(19) United States
(12) Patent Application Publication
(10) Pub. No.: US 2019/0256063 A1
(43) Pub. Date: Aug. 22, 2019

(54) DECELERATION DETERMINATION DEVICE AND NON-TRANSITORY COMPUTER READABLE STORAGE MEDIUM FOR STORING PROGRAM THEREOF

(71) Applicant: DENSO CORPORATION, Kariya-city (JP)

(72) Inventor: Kei Tamura, Kariya-city (JP)

(21) Appl. No.: 16/275,181

(22) Filed: Feb. 13, 2019

(30) Foreign Application Priority Data
Feb. 20, 2018 (JP) 2018-027720

(51) Int. Cl. B60T 8/172; G06F 17/18; B60W 30/18; B60W 30/085

(52) U.S. Cl. CPC B60T 8/172; G06F 17/18; B60W 30/18109; B60T 7/22; B60W 2550/302; B60W 2720/106; B60W 2520/10; B60W 30/085

(57) ABSTRACT

A CPU in a deceleration determination device detects a probability of whether the own vehicle will collide with a preceding vehicle. The CPU determines a first deceleration of the own vehicle when detecting that the own vehicle will collide with the preceding vehicle and the preceding vehicle accelerates at a first acceleration. The CPU determines a second deceleration of the own vehicle when detecting that the own vehicle will collide with the preceding vehicle and the preceding vehicle accelerates at a second acceleration. A magnitude of the second acceleration is greater than a magnitude of the first acceleration. The second deceleration is smaller than the first deceleration.

### CROSS-REFERENCE TO RELATED APPLICATION

This application is related to and claims priority from Japanese Patent Application No. 2018-27720 filed on Feb. 20, 2018, the contents of which are hereby incorporated by reference.

### TECHNICAL FIELD

The present disclosure relates to devices and non-transitory computer readable storage mediums for storing programs for determining deceleration of a vehicle.

### BACKGROUND

Related techniques have not considered determining appropriate deceleration of an own vehicle on the basis of a relationship between acceleration of a preceding vehicle and deceleration caused by automatic braking of the own vehicle during a preceding-vehicle following control.

### SUMMARY

The present disclosure provides the following device. A deceleration determination device which has a central processing unit capable of providing a detection part, a deceleration part and a deceleration determination part. The detection part detects a probability of whether the own vehicle will collide with a preceding vehicle. The deceleration determination part determines a first deceleration of the own vehicle when the detection part has been detected that the own vehicle will collide with the preceding vehicle and the preceding vehicle accelerates at a first acceleration. The deceleration determination part determines a second deceleration of the own vehicle when the detection part has been detected that the own vehicle will collide with the preceding vehicle and the preceding vehicle accelerates at a second acceleration.

### BRIEF DESCRIPTION OF THE DRAWINGS

A preferred, non-limiting embodiment of the present disclosure will be described by way of example with reference to the accompanying drawings, in which:

FIG. 1 is a block diagram showing a deceleration determination device and other devices mounted on an own vehicle according to a first exemplary embodiment of the present disclosure;

FIG. 2 is a view showing a flow chart of a collision estimation process as a first half of a deceleration determination process according to the first exemplary embodiment of the present disclosure;

FIG. 3 is a view showing a flow chart of a second half of the deceleration determination process performed by the deceleration determination device shown in FIG. 1;

FIG. 4 is a graph showing an example of a relative speed and a relative acceleration between the own vehicle and a preceding vehicle; and

FIG. 5 is a view showing a flow chart of the deceleration determination process according to a second exemplary embodiment of the present disclosure.

### DETAILED DESCRIPTION OF THE PREFERRED EMBODIMENTS

Hereinafter, various embodiments of the present disclosure will be described with reference to the accompanying drawings. In the following description of the various embodiments, like reference characters or numerals designate like or equivalent component parts throughout the several diagrams.

### First Exemplary Embodiment

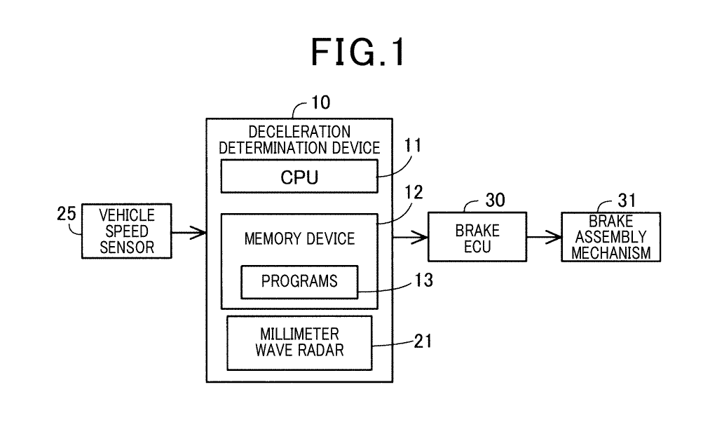

A description will be given of a deceleration determination device 10 and non-transitory computer readable storage medium for storing programs according to a first exemplary embodiment of the present disclosure with reference to FIG. 1 to FIG. 4.

FIG. 1 is a block diagram showing the deceleration determination device 10 and other devices mounted on an own vehicle according to the first exemplary embodiment of the present disclosure. As shown in FIG. 1, the deceleration determination device 10 and other devices such as a vehicle speed sensor 25, a brake electronic control device 30 (the brake ECU 30), a brake assembly mechanism 31, etc. are amounted on an own vehicle. The deceleration determination device 10 is composed of a computer system and a millimeter wave radar 21. The computer system is composed of a central processing unit 11 (CPU 11), a memory unit 12, etc. In particular, an electronic control unit (ECU) is a computer system composed of the CPU 11 and the memory unit 12. The ECU and the millimeter wave radar 21 are accommodated together in a casing. The ECU and other electronic control units are mounted on the own vehicle.

The millimeter wave radar 21 detects presence of an object which is present in a forward moving direction of the own vehicle a road. The millimeter wave radar 21 further detects an inter-vehicle distance between the own vehicle and the detected object, and a relative speed between the own vehicle and the detected object.

The memory unit 12 is semiconductor memories including a non-transitory computer readable storage medium for storing programs. The memory unit 12 stores programs. The CPU 11 reads the programs stored in the memory unit 12 and executes the programs so as to perform the deceleration determination process which will be explained later.

As shown in FIG. 1, the deceleration determination device 10 having the CPU 11 receives and transmits detection signals and various types of data such as control data from/to the vehicle speed sensor 25, the brake ECU 30.

The brake ECU 30 is a dedicated electronic control unit of the brake assembly mechanism 31 so as to perform the brake control. As shown in FIG. 1, the brake ECU 30 is electrically connected to the deceleration determination device 10 and the brake assembly mechanism 31.

The brake ECU 30 receives a deceleration request generated by and transmitted from the deceleration determination device 10, and performs the brake control of the brake assembly mechanism 31 on the basis of the received deceleration request.

The brake assembly mechanism 31 is composed of various brake control sensors, electric motors, valves, pumps, and various actuators, etc.

The vehicle speed sensor 25 detects a moving speed of the own vehicle, and transmits the detection signal to the deceleration determination device 10.

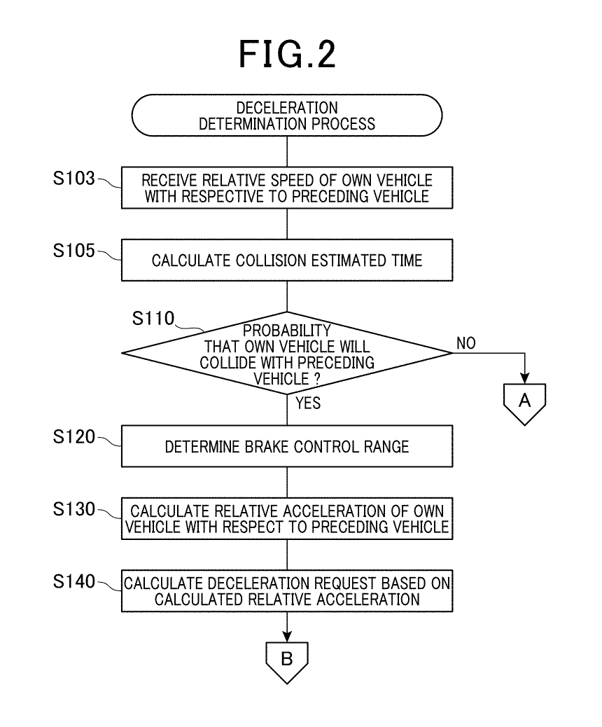

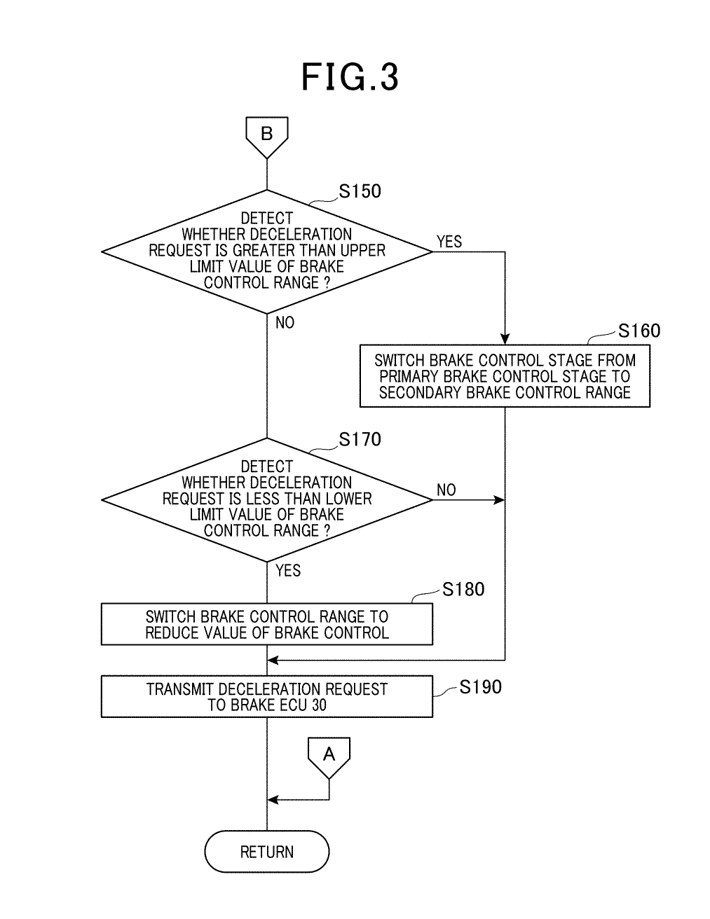

FIG. 2 is a view showing a flow chart of a collision estimation process, i.e. showing a first half of the deceleration determination process according to the first exemplary embodiment of the present disclosure. FIG. 3 is a view showing a flow chart of a second half of the deceleration determination process. The CPU 11 in the deceleration determination device 10 repeatedly performs the deceleration determination process shown in FIG. 2 and FIG. 3.

In step S103 shown in FIG. 2, the CPU 11 receives a detection signal regarding the relative speed of the own vehicle with respective to a preceding vehicle transmitted from the millimeter wave radar 21. The preceding vehicle is running in front of the own vehicle on a roadway or the same drive lane. The operation flow progresses to step S105.

In step S105, the CPU 11 calculates a collision estimated time on the basis of the received relative speed. For example, the CPU 11 calculates the collision estimated time by dividing an inter-vehicle distance between the own vehicle and the preceding vehicle by the relative speed.

The operation flow progresses to step S110. In step S110, the CPU 11 calculates a probability of whether the own vehicle will collide with the preceding vehicle. Specifically, the CPU 11 detects whether the collision estimated time is not more than a first reference time T1 which has been determined in advance. When the detection result indicates positive (“YES” in step S110), i.e. indicates that the collision estimated time is not more than the first reference time T1, the operation flow progresses to step S120.

In step S120, the CPU 11 determines there is a probability that the own vehicle will collide with the preceding vehicle.

On the other hand, when the detection result indicates negative (“NO” in step S110), i.e. indicates that the collision estimated time is more than the first predetermined reference time T1, the CPU 11 finishes the execution of the deceleration determination process shown in FIG. 2 and FIG. 3. The operation flow returns to step S103.

As previously described, when the detection result indicates that the collision estimated time is not more than the first reference time T1 (“YES” in step S110), the operation flow progresses to step S120. In step S120, the CPU 11 determines there is a probability that the own vehicle will collide with the preceding vehicle. Further, the CPU 11 determines a brake control range, i.e. selects, one of a primary brake control range and a secondary brake control range.

The CPU 11 determines, i.e. selects, one of the primary brake control range and the secondary brake control range on the basis of the collision estimated time. Specifically, the CPU 11 selects the primary brake control range when the collision estimated time is not less than a second reference value T2 which has been determined in advance, and the collision estimated time is not more than the first reference time T1.

On the other hand, the CPU 11 selects the secondary brake control range when the collision estimated time is less than the second reference value T2.

When selecting the primary brake control range, the CPU 11 maintains a deceleration of the own vehicle within a primary brake range.

On the other hand, when selecting the secondary brake control range, the CPU 11 maintains the deceleration of the own vehicle within a secondary brake range. In particular, an upper limit value of the primary brake range is not more than a lower limit value of the secondary brake range. The CPU 11 uses the brake range which is composed of the primary brake range and the secondary brake range. The lower limit value of the primary brake range is greater than zero G.

In the first exemplary embodiment, the deceleration is expressed by using a positive value. Increasing of the positive value corresponds to increasing deceleration of the own vehicle. For example, the brake ECU 30 instructs the brake assembly mechanism 31 to more increase the deceleration of the own vehicle when the deceleration is 1 G as compared with 0.5 G. The deceleration of 1 G corresponds to an absolute value of acceleration of gravity.

The operation flow progresses to step S130. In step S130, the CPU 11 calculates a relative acceleration of the own vehicle with respect to the preceding vehicle. That is, the CPU 10 divides the relative speed by time so as to obtain the relative acceleration of the own vehicle with respect to the preceding vehicle.

The operation flow progresses to step S140. In step S140, the CPU 11 calculates the deceleration request on the basis of the collision estimated time and the relative acceleration.

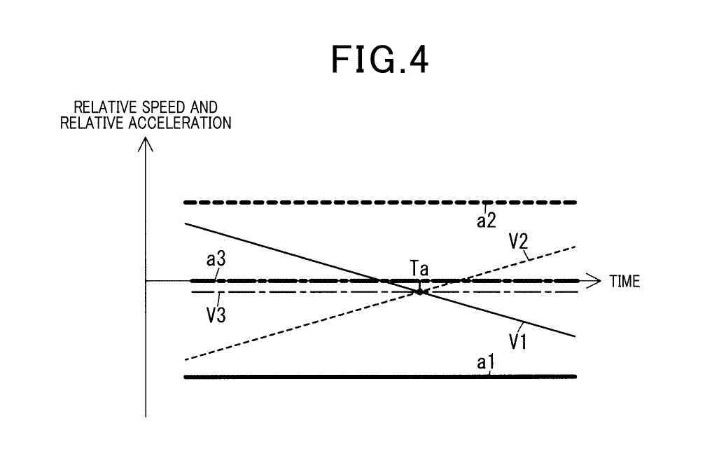

FIG. 4 is a graph showing an example of a relative speed and a relative acceleration of the own vehicle with respect to the preceding vehicle. As shown in FIG. 4, there are three cases. In the first case, the relative speed varies based on a first relative speed V1 designated by a solid line. In the second case, the relative speed varies based on a second relative speed V2 designated by a dotted line. In the third case, the relative speed does not vary as designated by a third relative speed V3 which is indicated by a long dashed short dashed line.

The first relative speed V1 represents that the relative speed is monotonically reduced. On the other hand, the second relative speed V2 represents that the relative speed monotonically increases.

As shown in FIG. 4, the first relative speed V1, the second relative speed V2 and the third relative speed V3 have the same value at time Ta. In other words, the collision estimated time at time Ta becomes the same value in the first relative speed V1, the second relative speed V2 and the third relative speed V3.

The first relative speed V1 has a negative value at time Ta. This represents that an inter-vehicle distance between the own vehicle and the preceding vehicle becomes a shorter. In this case, because the first relative acceleration al has a negative value, and the inter-vehicle distance between the own vehicle and the preceding vehicle is further reduced, it is necessary to increase the deceleration of the own vehicle.

On the other hand, since the second relative acceleration a2 is a positive value, a magnitude of the second relative acceleration a2 is greater than a magnitude of the first relative acceleration a1. Accordingly, although the second relative speed V2 has a negative value at timing Ta, when the second relative acceleration a2 is added into the second relative speed V2, the second relative speed V2 becomes an appropriate value which is smaller than the first relative speed V1.

As shown in FIG. 4, because the third relative speed V3 does not vary, a third relative acceleration a3 is zero. Accordingly, a magnitude of a necessary deceleration is smaller than a magnitude of the deceleration at the first relative speed V1, and greater than the deceleration at the second relative speed V2.

In the deceleration determination device 10 according to the first exemplary embodiment of the present disclosure, the CPU 11 determines the magnitude of the relative acceleration of the own vehicle to the preceding vehicle on the basis of positive and negative values of the relative acceleration in addition to an absolute value of the relative acceleration. Accordingly, the magnitude of a relative acceleration of a positive value becomes greater than the magnitude of a relative acceleration of a negative value.

The operation flow progresses to step S150 (see FIG. 3). In step S150, the CPU 11 detects whether the deceleration request calculated in step S140 is greater than the upper limit value of the brake range. This brake range is composed of the primary brake range and the secondary brake range, as previously described.

When the detection result in step S150 indicates positive (“YES” in step S150), i.e. indicates that the deceleration request calculated in step S140 is greater than the upper limit value of the brake range, the operation flow progresses to step S160.

In step S160, the CPU 11 instructs the brake ECU 30 to switch the brake control range from the primary brake control range to the secondary brake control range.

When the secondary brake control range has been selected in step S120, because the magnitude of the deceleration provided by the secondary brake control range has a maximum value, the CPU 11 maintains the secondary brake control range even if the deceleration request exceeds the upper limit value of the deceleration in the secondary brake control range.

In a modification of the first exemplary embodiment, it is acceptable to add a third brake control range, and to use a third brake control range which is greater in braking than the upper limit value of the secondary brake control range.

When the detection result in step S150 indicates negative (“NO” in step S150), i.e. indicates that the deceleration request calculated in step S140 is not greater than the upper limit value of the brake range, the operation flow progresses to step S170.

In step S170, the CPU 11 detects whether the deceleration request is less than the lower limit value of the brake control range at the current state.

When the detection result in step S170 indicates positive (“YES” in step S170), i.e. indicates that the deceleration request is less than the lower limit value of the brake control range, the operation flow progresses to step S180.

In step S180, when the secondary brake control range has been selected, the CPU 11 switches the brake control range from the secondary brake control range to the primary brake control range so as to reduce a value of the brake control.

When the primary brake control range has been selected in step S120, because the magnitude of the deceleration provided by the primary brake control range has a minimum value, the CPU 11 maintains the primary brake control range even if a magnitude of the deceleration request becomes smaller than the lower limit value of the deceleration in the primary brake control range.

In a modification of the first exemplary embodiment, it is acceptable for the CPU 11 to set the deceleration request to zero.

On the other hand, when the detection result in step S170 indicates negative (“NO” in step S170), i.e. indicates that the deceleration request is not less than the lower limit value of the brake control range, the operation flow progresses to step S190.

When the process in step S160 or the process in step S180 is finished, the operation flow progresses to step S190.

In step S190, the CPU 11 transmits the deceleration request calculated in step S140 to the brake ECU 30. The CPU 11 finishes the deceleration determination process.

The deceleration determination device 10 having the structure previously described according to the first exemplary embodiment makes it possible to determine an appropriate deceleration of the own vehicle on the basis of the acceleration of the preceding vehicle. The deceleration determination device 10 makes it possible to suppress the deceleration of the own vehicle from becoming larger than necessary when the preceding vehicle accelerates and the relative acceleration of the own vehicle with respect to the preceding vehicle is a positive value, and to suppress deficiency of the deceleration from occurring when the preceding vehicle decelerates and the relative acceleration is a negative value.

Further, it is possible for the deceleration determination device 10 to determine an appropriate magnitude of the deceleration because of determining the deceleration regardless of the primary brake control range or the secondary brake control range determined based on the collision estimated time.

### Second Exemplary Embodiment

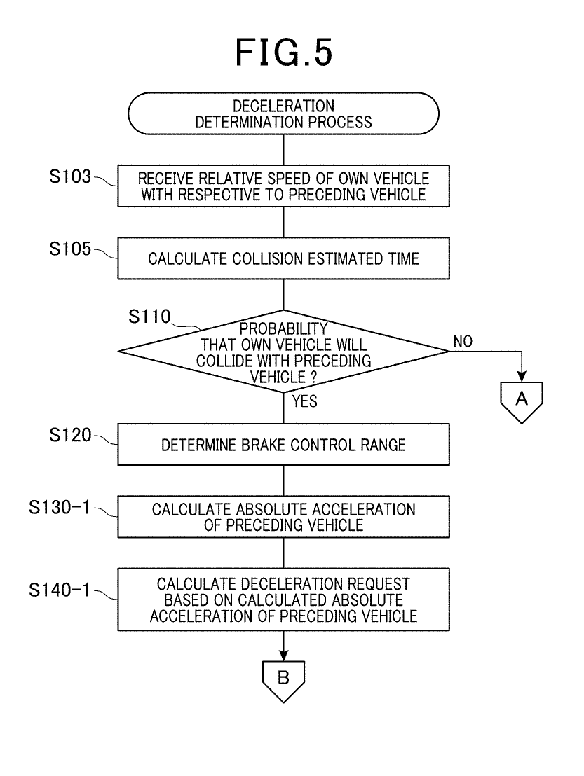

A description will be given of the deceleration determination device 10 according to a second exemplary embodiment of the present disclosure with reference to FIG. 5.

FIG. 5 is a view showing a flow chart of the deceleration determination process performed by the deceleration determination device 10 according to the second exemplary embodiment of the present disclosure.

The CPU 11 in the deceleration determination device 10 according to the second exemplary embodiment performs the same processes in step S103, step S105, step S110 and step S120 shown in FIG. 2 and the processes in step S150 to step S190 shown in FIG. 3 performed by the deceleration determination device 10 according to the first exemplary embodiment. The processes in step S130-1 and step S140-1 are different from the processes in step S130 and S140 shown in FIG. 2.

In step S130-1 shown in FIG. 5, the CPU 11 calculates an absolute acceleration of the preceding vehicle. It is possible for the CPU 11 divides an absolute speed of the preceding vehicle by time so as to obtain the absolute acceleration of the preceding vehicle. The CPU 11 receives a relative speed transmitted from the millimeter wave radar 21 and a vehicle speed of the own vehicle transmitted from the vehicle speed sensor 25, and to calculate the absolute speed of the preceding vehicle on the basis of the received relative speed and the received vehicle speed.

The operation flow progresses to step S140-1. In step S140-1, the CPU 11 calculates the deceleration request on the basis of the calculated absolute acceleration of the preceding vehicle.

As previously described, it is possible for the deceleration determination device 10 according to the second exemplary embodiment to determine an appropriate deceleration of the own vehicle on the basis of the absolute acceleration of the preceding vehicle.

The process in step S110 corresponds to a detection part. The process in step S120 corresponds to a deceleration range determination part.

The process in step S140 and the process in step S140-1 correspond to a deceleration determination part. The processes in step S160 and step S180 correspond to a deceleration range switch part.

The concept of the present disclosure is not limited by the first exemplary embodiment and the second exemplary embodiment previously described. For example, it is possible to have the following modification of the present disclosure.

In the first exemplary embodiment and the second exemplary embodiment, the millimeter wave radar 21 and the ECU composed of the CPU 11 and the memory unit 12 are accommodated together in the casing. However, the concept of the present disclosure is not limited by the first exemplary embodiment and the second exemplary embodiment. For example, it is acceptable to arrange the ECU and the millimeter wave radar 21 at different locations on the own vehicle. That is, it is acceptable for the casing to accommodate the memory unit 12 and the millimeter wave radar 21, and to arrange the ECU at a different location.

In order to calculate an inter-vehicle distance between the own vehicle and a detected object such as a preceding vehicle and to detect a relative speed of the own vehicle with respect to the preceding vehicle, it is acceptable to use a light detection and ranging or a laser imaging detection and ranging (LIDAR) and a stereo camera, instead of using the millimeter wave radar 21. Further, it is acceptable to use vehicle-to-infrastructure communication and vehicle-to-vehicle communication (V2V communication) between the own vehicle and a preceding vehicle so as to detect a location of a preceding vehicle and an absolute speed of the preceding vehicle. In this case, it is also possible to calculate a relative speed of the own vehicle with respect to the preceding vehicle, and to calculate the inter-vehicle distance between the own vehicle and the preceding vehicle on the basis of the location of the preceding vehicle and the absolute speed of the preceding vehicle.

It is acceptable for the deceleration determination device 10 to determine the deceleration of the own vehicle on the basis of both the relative acceleration and the absolute acceleration.

It is possible to use hardware devices so as to realize the functions and the processes performed by executing software programs. It is acceptable to use software programs so as to realize a part or the overall of the functions of the hardware devices. Specifically, it is acceptable to use integrated circuits, discrete circuits, or various circuits and circuit modules composed of a combination of integrated circuits and discrete circuits.

In order to realize the memory unit 12, it is possible to use semiconductor memories including a non-transitory computer-readable storage medium for storing programs.

While specific embodiments of the present disclosure have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present disclosure which is to be given the full breadth of the following claims and all equivalents thereof.

What is claimed is:

1. A deceleration determination device on an own vehicle, comprising a central processing unit capable of providing:
a detection part which detects a probability of whether the own vehicle will collide with a preceding vehicle which is running on a roadway; and
a deceleration determination part which determines a first deceleration of the own vehicle when the detection part has detected that the own vehicle will collide with the preceding vehicle and the preceding vehicle accelerates at a first acceleration, and determines a second deceleration of the own vehicle when the detection part has detected that the own vehicle will collide with the preceding vehicle and the preceding vehicle accelerates at a second acceleration, where a magnitude of the second acceleration is greater than a magnitude of the first acceleration, and a magnitude of the second deceleration is smaller than a magnitude of the first deceleration.

2. The deceleration determination device further comprising:
a deceleration range determination part which determines a deceleration range of the own vehicle; and
a deceleration range switch part which modifies the deceleration range determined by the deceleration range determination part when the deceleration of the own vehicle determined by the deceleration range determination part is outside from the deceleration range determined by the deceleration range determination part.

3. The deceleration determination device according to claim 1, wherein a relative acceleration of the own vehicle with respect to the preceding vehicle is used as the acceleration of the preceding vehicle.

4. The deceleration determination device according to claim 2, wherein a relative acceleration of the own vehicle with respect to the preceding vehicle is used as the acceleration of the preceding vehicle.

5. The deceleration determination device according to claim 1, wherein an absolute acceleration of the preceding vehicle is used as the acceleration of the preceding vehicle.

6. The deceleration determination device according to claim 2, wherein an absolute acceleration of the preceding vehicle is used as the acceleration of the preceding vehicle.

7. A non-transitory computer-readable storage medium, to be mounted on an own vehicle, for storing a program for causing a central processing unit to provide steps of:
detecting a probability of whether the own vehicle will collide with a preceding vehicle which is running on a roadway;
determining a first deceleration of the own vehicle when it has been detected that the own vehicle will collide with the preceding vehicle and the preceding vehicle accelerates at a first acceleration, and
determining a second deceleration of the own vehicle when it has been detected that the own vehicle will collide with the preceding vehicle and the preceding vehicle accelerates at a second acceleration, where a magnitude of the second acceleration is greater than a magnitude of the first acceleration, and the magnitude of the second deceleration is smaller than the magnitude of the first deceleration.
